(19) United States
(12) Patent Application Publication
(10) Pub. No.: US 2022/0379791 A1
(43) Pub. Date: Dec. 1, 2022

(54) TRAILER FOR OFF-ROAD VEHICLE

(71) Applicant: MAHINDRA VEHICLE MANUFACTURERS LTD., Troy, MI (US)

(72) Inventors: Tony BULCHAK, Hazel Park, MI (US); Anthony PACELLA, Ortonville, MI (US); Mark LEBLANC, Auburn Hills, MI (US); Aaron CARLSON, Waterford, MI (US); Jasneet JHITA, Commerce Township, MI (US); Timothy SHELDON, Farmington, MI (US); Robert MOONEY, Clarkston, MI (US)

(73) Assignee: MAHINDRA VEHICLE MANUFACTURERS LTD., Troy, MI (US)

(21) Appl. No.: 17/773,536

(22) PCT Filed: Oct. 30, 2020
(86) PCT No.: PCT/US2020/058109

§ 371 Date: Apr. 29, 2022

Related U.S. Application Data
(60) Provisional application No. 62/929,556, filed on Nov. 1, 2019.

(51) Int. Cl. B60P 1/267; B62D 63/06; B62D 63/08; B60P 1/28

(52) U.S. Cl. CPC B60P 1/267; B62D 63/062; B62D 63/08; B60P 1/283; B60P 1/16

(57) ABSTRACT

A trailer is provided with a frame to connect to an off-road vehicle. A body is pivotally connected relative to the frame and includes a bed and a side panel extending transversely from the bed to define a cargo area. A pitch actuator assembly is coupled between the frame and the body to pivot the body between a storage position and an elevated position. A bracket is connected to a rearward end of the side panel. A tailgate is pivotally connected to a lower portion of the bracket about a first horizontal axis to adjust between a closed position and an open-downward position, and pivotally connected to an upper portion of the bracket about a second horizontal axis to adjust between the closed position and an open-upward position.

### CROSS-REFERENCE TO RELATED APPLICATIONS

This application claims the benefit of U.S. provisional application Ser. No. 62/929,556 filed Nov. 1, 2019, the disclosure of which is hereby incorporated in its entirety by reference herein.

### TECHNICAL FIELD

One or more embodiments relate to a trailer for an off-road vehicle.

### BACKGROUND

Off-road vehicles are often used to carry took; and equipment to a jobsite at a remote location. Such remote locations may include rough terrain with limited space to perform intricate work. Accordingly, the user of such. an. off-road vehicle may attach a trailer to the vehicle to carry additional equipment.

### SUMMARY

A trailer is provided with a frame and a sub-frame supported by the frame and pivotal about a first horizontal axis relative to the frame. The trailer is also provided with. a body and a tailgate. The body includes a bed mounted to the sub-frame and side panels extending transversely from the bed, wherein the body is pivotal between a storage position and an extended position relative to the frame. The tailgate is pivotally connected to a rearward end of each side panel about a second horizontal axis for adjusting between a closed position and an open-downward position, and about a third horizontal axis for adjusting between the closed position and an open-upward position, wherein the second horizontal axis is vertically offset from the third horizontal axis. The trailer is also provided with. a pitch actuator coupled between the frame and the sub-frame for pivoting the sub-frame and the body about the first horizontal axis between the storage position and the extended position, and a linkage assembly for supporting the frame and body as they are adjusted.

In another embodiment, a trailer is provided with a frame to connect to an off-road vehicle. A body is pivotally connected relative to the frame and includes a bed and a side panel extending transversely from the bed to define a cargo area. A pitch actuator assembly is coupled between the frame and the body to pivot the body between a storage position and an elevated position. A bracket is connected to a rearward end of the side panel. A tailgate is pivotally connected to a lower portion. of the bracket about a first horizontal axis to adjust between a closed position and an open-downward position, and pivotally connected to an upper portion of the bracket about a second horizontal axis to adjust between the closed position and an open-upward position.

in yet another embodiment, a trailer is provided with a frame to connect to an off-road. vehicle, A body is supported by the frame and includes a bed and a side panel extending transversely from the bed to define a cargo area. The body is pivotally connected relative to the frame to adjust between a storage position and an elevated position. A bracket is connected to a rearward end of the side panel, A. tailgate is pivotally connectable to a lower portion of the bracket about a first axis to adjust between a closed position and a first open position, and is pivotally connectable to an upper portion of the bracket about a second axis to adjust between the closed position and a second open. position.

In still yet another embodiment, a trailer is provided with a frame to connect to an off-road vehicle. A body is supported by the frame and includes a bed and a side panel extending transversely from the bed to define a cargo area. The body is pivotally connected relative to the frame and adjustable between a storage position and an elevated position. A linkage assembly is coupled. between the frame and the body with a first link pivotally connected to the frame about a first joint. A linear actuator is supported by the linkage assembly to travel along an arcuate path in response to pivotal motion of the first link, and to extend to adjust the body between the storage position and the elevated position.

### BRIEF DESCRIPTION OF THE DRAWINGS

FIG. 1 is a front perspective view of a trailer in accordance with one or more embodiments, illustrated with a frame connected to an off-road vehicle.

FIG. 2 is a side view of the trailer of FIG. 1 illustrated in a storage position and illustrated with a tailgate in an open-downward position shown in dashed line.

FIG. 3 is a side view of the trailer of FIG. 1 illustrated in an intermediate position and illustrated with a tailgate in an open-upward position shown in dashed line.

FIG. 4 is a side view of the trailer of FIG. 1 illustrated in an elevated position and illustrated with a tailgate in the open-upward position shown in dashed line.

FIG. 5 is a top rear perspective view of the trailer of FIG. 1, illustrated with the tailgate in the open-downward position.

FIG. 6 is a top rear perspective view of the trailer of FIG. 5 without a body, illustrating a sub-frame connected to the frame.

FIG. 7 illustrates a rear perspective view of a pitch actuator assembly of the trailer of FIG. 2.

FIG. 8 illustrates a front exploded view of the pitch actuator assembly.

FIG. 9 is an enlarged side view of the pitch actuator assembly, illustrated in the storage position.

FIG. 9A is a diagram illustrating a linkage assembly arrangement of the pitch actuator assembly of FIG. 9.

FIG. 10 is another enlarged view of the pitch actuator assembly, illustrated in the elevated position.

FIG. 10A is a diagram illustrating a linkage assembly arrangement of the pitch actuator assembly of FIG. 10.

FIG. 11 is a top rear perspective view of a trailer in accordance with one or more embodiments, illustrated with a tailgate in. the open-downward position.

FIG. 11A is an enlarged view of a pivot pin of the tailgate of FIG. 11.

FIG. 12 is another top rear perspective view of the trailer of FIG. 11, illustrated with the tailgate in an open-upward raised platform position.

FIG. 13 is an enlarged view of a clevis mechanism of the trailer of FIG. 11.

FIG. 14 is a side view of a clevis of the clevis mechanism of FIG. 14, illustrated with the tailgate in the open-downward position.

FIG. 15 is another side view of the clevis, illustrated receiving the pivot pin of the tailgate.

FIG. 16 is yet another side view of a clevis, illustrated with the tailgate in the open-downward position.

### DETAILED DESCRIPTION

As required, detailed embodiments of the present invention are disclosed herein; however, it is to be understood that the disclosed embodiments arc merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

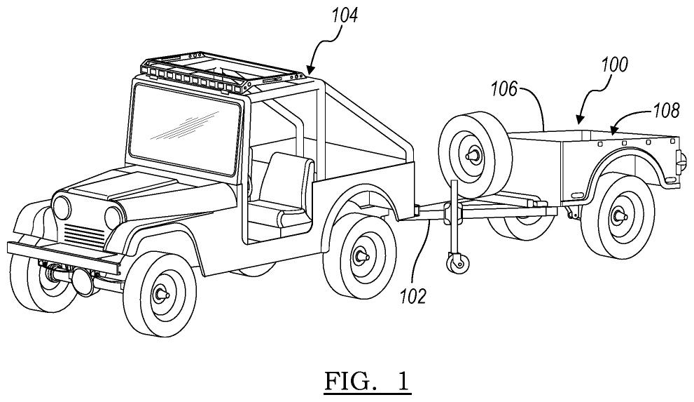

With reference to FIG. 1, a trailer is illustrated in accordance with one or more embodiments and generally referenced by numeral 100. The trailer 100 includes a frame 102 for connecting to a vehicle 104, such as an off-road vehicle. The trailer 100 also includes a body 106 that defines a cargo area 108.

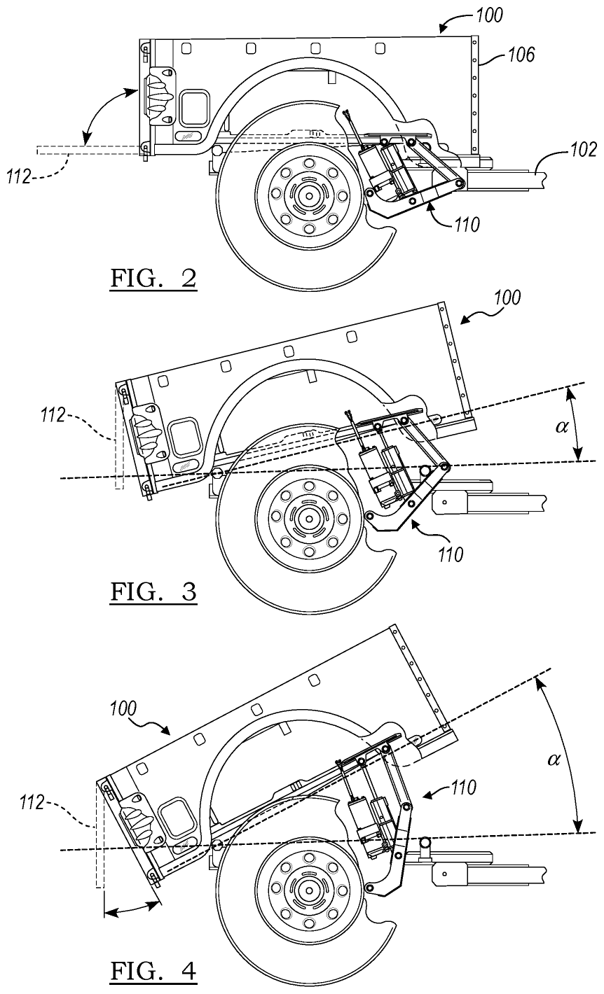

Referring to FIGS. 2-4, the trailer 100 includes a pitch actuator assembly 110 for adjusting a pitch angle (α) of the body 106 relative to the frame 102. The pitch actuator assembly 1.10 is pivotally mounted to the frame 102 and adjusts to lift a forward end of the body 106 upward from a storage position (FIG. 2) to an intermediate position (FIG. 3) and further to an elevated position (FIG. 4) between a pitch angle (α) of approximately 0-30 degrees. In one embodiment, the elevated position illustrated in FIG. 4 corresponds to a pitch angle (α) of approximately twenty-six degrees.

The trailer 100 also includes a tailgate 112 that is pivotally connected to the body 106 about multiple axes. As shown in FIG. 2, the tailgate 112 is pivotally connected to a lower portion of the body 106 to extend from a closed position to an open-downward position (shown in dashed line). As shown in FIGS. 3-4, the tailgate 112 is also pivotally connected to an upper portion of the body 106 to extend from the closed position to an open-upward position (shown in dashed line). While the tailgate 112 is in the open-upward position, the pitch actuator assembly 110 can increase the pitch angle (α) of the body 106 to empty contents of the trailer 100 onto the ground to provide a “dump” feature.

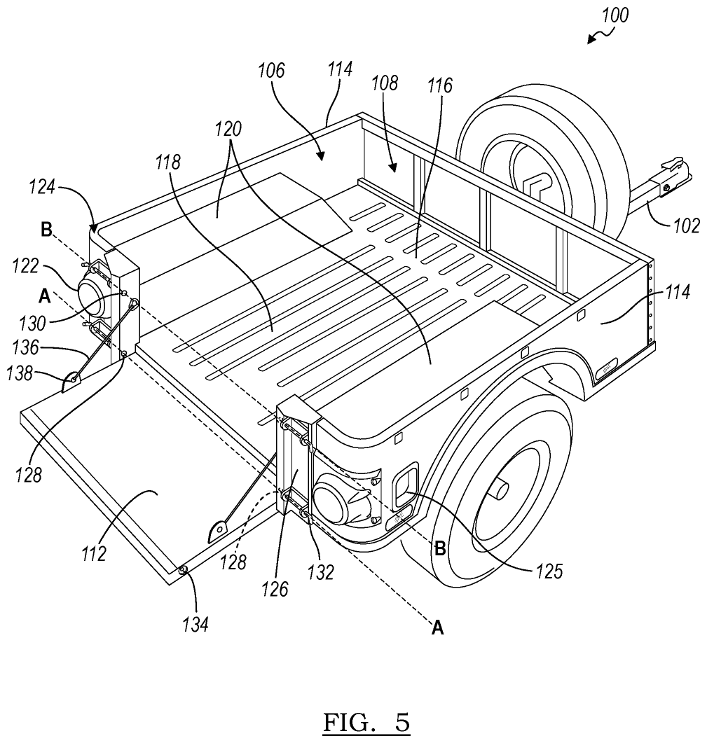

Referring to FIG. 5, the body 106 includes side panels 114 and a bed 116 that define the cargo area 108. The bed 116 is supported by the frame 102 and the side panels 114 extend transversely from the bed 116. The panels 114 may be formed of a solid rigid material, such as steel or aluminum, much like the panels of the vehicle 104, to provide high strength. The bed 116 includes a generally flat central surface 118 and outer surfaces 120 that arc raised to accommodate the wheel wells. In one or more embodiments, the central surface 118 and/or the outer surfaces 120 are formed with, or coated with, a textured surface to provide a bedliner for easy clean-up. The trailer 100 includes rear tail lamps 122 that are mounted to rearward portions 124 of the side panels 114. The rear tail lamps 122 include semiconductor light sources, e.g., light emitting diodes, according to one or more embodiments. The trailer 100 also includes a. switch 125 for controlling the pitch actuator assembly 110. The trailer 100 includes a harness (not shown) for connecting electrical components, e.g., the pitch actuator assembly 110, the tail lamps 122, and the switch 125 to an electrical power source, e.g., a battery that may be mounted on. the trailer 100 and/or the vehicle 104.

The tailgate 112 is pivotably connected to the body 106 to provide access to the cargo area 108. The body 106 includes a pair of brackets 126 that extend from the bed 116 along the rearward portion 124 of each side panel 114. Each bracket 126 includes a lower aperture 128 that is aligned with the other lower aperture 128 along a first horizontal Axis A-A. Each bracket 126 also includes an upper aperture 130 that is aligned with the other upper aperture 130 along a second horizontal Axis B-B. The trailer 100 includes fasteners 132, such as spring-loaded pins, that are supported by the brackets 126 and biased to engage holes 134 formed in the tailgate 11.2 to provide pivotal connections. As shown in FIG. 5, the tailgate 112 pivots about Axis A-A to open downward by disengaging the upper fasteners 132 from the upper holes 134. In the illustrated embodiment, the trailer 100 includes a flexible cable 136 that is connected between each bracket 126 and a cable bracket 138 that is located at a central side portion of the tailgate 112. The flexible cable 136 supports, and provides an end-stop for, the tailgate 112 when. it is oriented in the open-downward position. in. other embodiments, the tailgate 212 may be pivotally connected to the brackets 126 about one or more vertical axes to provide a tailgate 212 that opens outward (not shown).

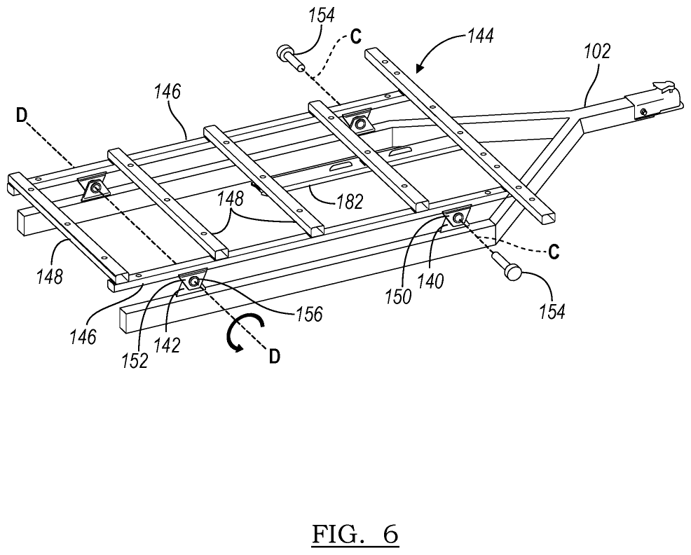

With reference to FIGS. 5-6, the body 106 is supported by the frame 102. The frame 102 includes a pair of forward brackets 140 that are aligned with each other along Axis C-C, and a pair of rearward brackets 142 that are aligned with each other along Axis D-D. Each bracket 140, 142 has an aperture thrilled through. The trailer 100 includes a sub-frame 144 that includes a pair of rails 146 and a plurality of cross-members 148 that extend between the rails 146. The body 106 is mounted to the sub-frame 144, e.g., by a plurality of fasteners that extend through the bed 116 to engage apertures in the cross-members 148. The sub-frame 144 includes a pair of front brackets 150 and a pair of rear brackets 152 each having an aperture thrilled through.

The body 106 is pivotally coupled to the frame 102 by the sub-frame 144. The front brackets 150 are aligned with each other, and aligned with the forward brackets 140 of the frame 102, along Axis C-C. Each front bracket 150 is connected to a corresponding forward bracket 140 by a removable fastener 154. The rear brackets 152 are aligned with each other, and aligned with the rearward brackets 142 of the frame 102, along Axis D-D. Each rear bracket 152 is pivotally connected to a corresponding rearward bracket 142 by a pivot pin 156. By removing the fasteners 154, the sub-frame 144 and the body 106 can pivot about the pivot pins 156 (Axis D-D) to adjust the pitch angle of the body 106 relative to the frame 102.

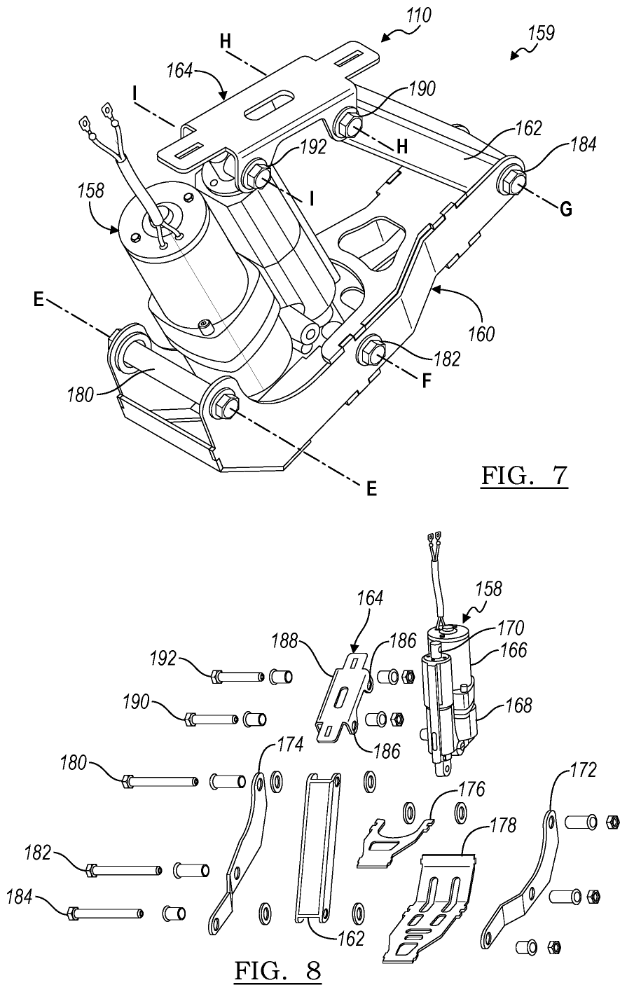

Referring to FIGS. 7-8, the pitch actuator assembly 110 adjusts the pitch angle (α) of the body 106 relative to the frame 102 (shown in FIGS. 2-4). The pitch actuator assembly 110 includes a linear actuator 158 and a linkage assembly 159. The linkage assembly 159 includes a lower link assembly 160, a rear link 162, and an upper link 164.

The linear actuator 158 is an electromechanical linear actuator, including an electric motor 166 and transmission 168 that drive a piston 170, according to one or more embodiments. The linear actuator 158 is designed to lift a load, including the body 106, the sub-frame 144 and cargo, of approximately 2,000 lbs. The linear actuator 158 pivots relative to the frame 102 and the piston 170 extends approximately 150 mm, which corresponds to a pitch angle of approximately 26 degrees. In one embodiment, the linear actuator 158 is a compact electro-hydrattlic actuator by Parker with. a maximum stroke of 152 mm, and a maximum thrust force of 21.35 kN.

The lower link assembly 160 includes a first lower link 172 and a second lower link 174 that are generally mirror images of each other, and laterally spaced apart from each other by an upper bracket 176 and a lower bracket 178. The first lower link 172 and the second lower link 174 are connected to each other by: a first joint 180, a second joint 182, and a third joint 184 that extend through a forward end, a central portion, and a rearward end of the links 172, 174, respectively.

The rearward end of the lower link assembly 160 is pivotally connected to the frame 102 at the first joint 180, which extends along Axis E-E. The linear actuator 158 includes a proximal end that is pivotally connected to the central portion of the lower link assembly 160 at the second joint 182, which extends along Axis F-F. The forward end of the lower link assembly 160 is pivotally connected to a front end of the rear link 162 at the third joint 184, which extends along Axis G-G.

The upper link 164 includes a pair of flanges 186 that extend transversely from a base 188 to support a fourth joint 190 and. a fifth joint 192—A rearward end of the rear link 162 is pivotally connected to a front end of the upper link 164 at the fourth joint 190, which extends along Axis A distal end of the linear actuator 158 is pivotally connected to a rearward end of the upper link 164 at the fifth joint 192, which extends along Axis I-I. The upper link 164 is mounted to an actuator mounting bracket 194 of the sub-frame 144 (FIG. 6) for distributing the load.

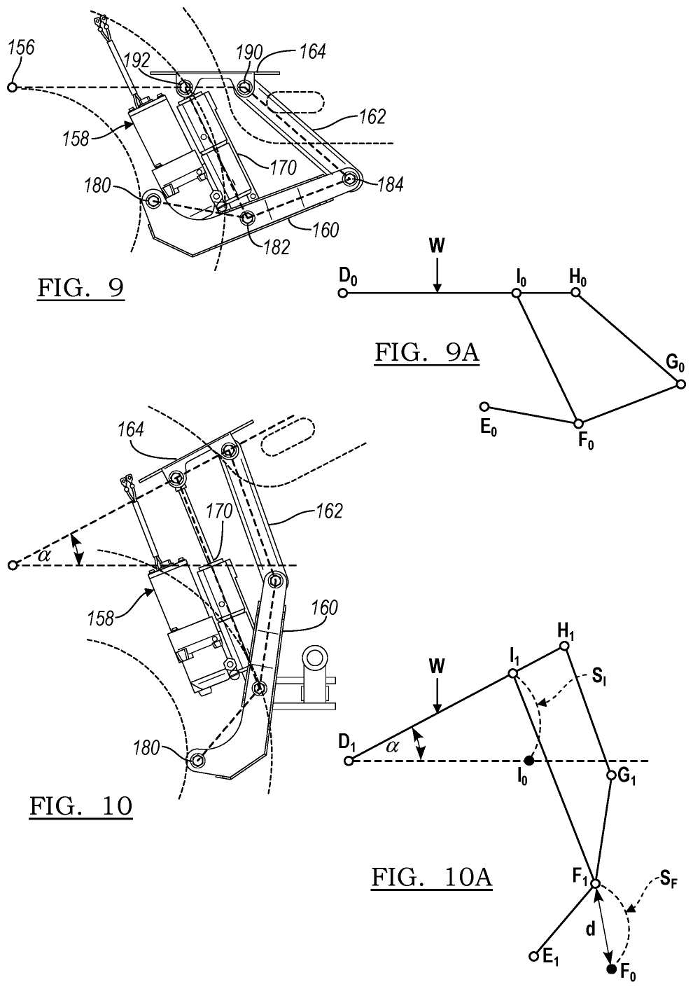

With reference to FIGS. 9-10A, the linkage assembly 159 converts linear motion of the piston 170 of the linear actuator 158 to arcuate motion, or angular travel of the body 106 relative to the frame 102. As the piston 170 extends, the lower link assembly 160 pivots counter clockwise about the first joint 180 (Axis E) (as viewed in FIG. 9) and pivots the upper link 164 upward about the pivot pins 156 (Axis D) along the pitch angle (α) while the links 160, 162 pivot away from each other about the third joint 184 (Axis G).

The motion of the pitch actuator assembly 110 may be represented by linkage diagrams, as shown in FIGS. 9A and 10A, with six links and seven joints. The seven joints include six revolute. joints that are aligned with axes D-J (shown in FIGS. 6 and 7), and one sliding joint which corresponds to the stroke of the piston 170 of the linear actuator 158. The links in FIGS. 9A and 10A are represented by the Axes that each link pivots relative to. Link D1 represents the distance between the pivot pin 156 (Axis D) and the fifth joint 192 (Axis 1). Link represents the distance between the fifth joint 192 (Axis I) and the fourth joint 190 (Axis F). Link EF represents the distance between the first joint 180 (Axis F) and the second joint 182 (Axis F). Link FG represents the distance between the second joint 182 (Axis F) and the third joint 184 (Axis G). Link GH represents the distance between the third joint 184 (Axis G) and the fourth joint 190. Link F1 represents the adjustable distance or stroke of the piston 170 between the second joint 182 (Axis H and the fifth joint 192 (Axis I).

The linkage assembly 159 reduces the thrust and stroke requirements of the linear actuator 158 as compared to a pitch actuator without a linkage assembly (not shown), The linear actuator 158 is designed to lift a load, including the body 106, the sub-frame 144 and cargo, of approximately 2,000 lbs. This load (W) is distributed between. Link F1 and Link OH.

As Link F1 extends, Links EF and FG pivot counterclockwise about Axis E and drive Links DI and IH to pivot counterclockwise about Axis D at the pitch angle (α). The arcuate motion of Joint F (i.e., the proximal end of the linear actuator 158) between an initial position F₀ and a final position F₁ is represented by arc length Sr, and the arcuate motion of Joint I (the distal end of the linear actuator 158) between an initial position to and a final position I₀ is represented by arc length S_{J}. As shown in the FIG. 10A, the linkage assembly 159 is designed so that S_{F} tracks S_{I}, which maximizes the efficiency of the linear actuator 155.

The linkage assembly 159 also reduces the stroke required of the linear actuator 158 by following the motion of the Link IH as represented by distance (d) in FIG. 10A. The linkage assembly 159 also distributes the load (W) between Links F1 and GH which allows the linear actuator 158 to be located closer to the pivot pin 156 (Axis D). Without the linkage assembly 159, a linear actuator located at the same longitudinal. distance from Joint D would require more output force, or a linear actuator with the same output force would require more stroke because it would need to he moved farther away from Joint D.

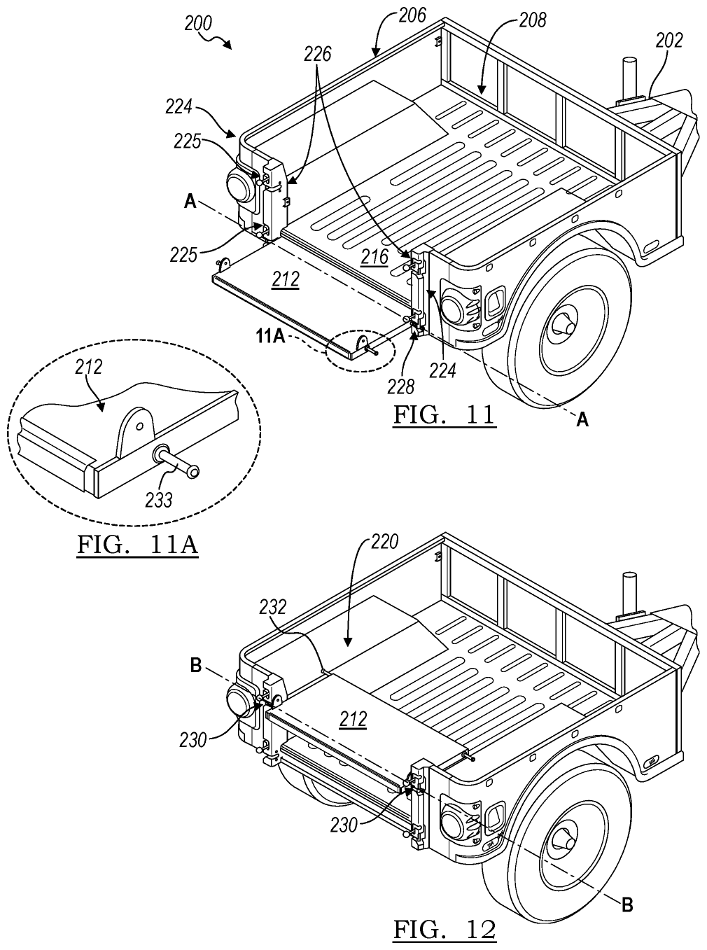

With reference to FIG. 11, a trailer is illustrated in accordance with one or more embodiments and generally referenced by numeral 200. The trailer 200 includes a frame 202 for connecting to a vehicle 104, such as the off-road vehicle shown in FIG. 1. The trailer 200 also includes a body 206 that defines a cargo area 208. The trailer 200 includes a tailgate 212 that is pivotally connected to the body 206 about multiple axes. The trailer 200 includes clevis mechanisms 225 for pivotally connecting the tailgate 212 to the body 206, rather than translating fasteners 132 as described with reference to the trailer 100 of FIG. 5.

The body 206 includes side panels 214 and a bed 216 that define the cargo area 208. The bed 216 includes a generally flat central surface 218 and outer surfaces 220 that are raised to accommodate the wheel wells. As shown in FIG. 11, the tailgate 212 is pivotally connected to a lower portion of the body 206 about Axis A-A to extend from a closed position to an open-downward position. As shown in FIG. 12, the tailgate 212 is also pivotally connected to an upper portion of the body 206 about Axis B-B to extend from the closed position to an open-upward position.

The trailer 200 includes four clevis mechanisms 225 for pivotally connecting the tailgate 212 to the body 206 about multiple axes (Axis A-A and Axis B-B). The body 206 includes a pair of brackets 226 that each extend vertically from the bed 216 along a rearward portion 224 of a corresponding side panel 214. Each bracket 226 supports a pair of clevis mechanisms 225, including a lower clevis 228 and an upper clevis 230. Each lower clevis 228 is aligned along Axis A-A (FIG. 11), and each upper clevis 230 is aligned along Axis B-B.

The trailer 200 includes two lower pivot pins 232 and two upper pivot pins 233 that are supported by the tailgate 212 and extend outward to engage corresponding clevis mechanisms 225 to provide pivotal connections. As shown in FIGS. 11 and 11A, the tailgate 212 pivots about Axis A-A to open downward by disengaging each upper pivot pin 233 from the corresponding upper clevis 230.

Referring to FIG. 12, the tailgate 212 pivots about Axis B-B to open upward by disengaging each lower pivot pin 232 from the corresponding lower clevis 228. The upper clevis 230 may be aligned with. the outer surface 220 at the wheel well such that the lower pivot pins 232 engage the outer surface 220 to limit the upward pivotal motion of the tailgate to approximately 270 degrees such that the tailgate provides a raised platform, as shown in FIG. 12. The tailgate 212 oriented in the raised platform position provides a work surface for a user when. they are in a remote location, e.g., in the woods or at a jobsite.

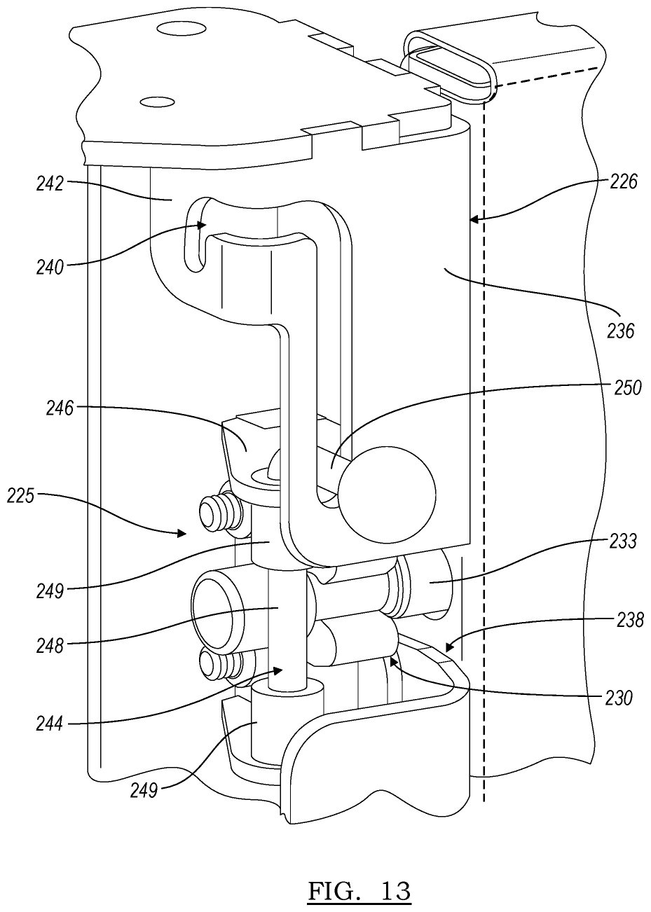

FIG. 13 illustrates the clevis mechanism 225 that is mounted to an upper portion of the left bracket 226. The bracket 226 includes a rearward surface 236 with an opening 238 formed through. The clevis mechanism 225 includes an upper clevis 230 that is mounted to an inner surface of the bracket 226 and arranged in the opening 238 for receiving the upper left pivot pin 233. The bracket 226 includes a slot 240 that extends upward along the rearward surface 236 and then extends to a side surface 242 of the bracket 226. The clevis mechanism 225 includes a clevis pin 244 to secure the upper pivot pin 233 within the upper clevis 230. The clevis mechanism 225 includes a clevis bracket 246 that supports the clevis pin 244 rearward of upper clevis 230. The clevis pin 244 includes an upright portion 248 that translates vertically within apertures formed through the clevis bracket 246. In one or more embodiments, the clevis mechanism 225 includes bushings 249 that are supported by the clevis bracket 2.46 within the apertures to provide a bearing surface for the clevis pin 2.44 during translation. The clevis pin 244 also includes a handle 250 that extends transversely from the upright portion. 248 and through the slot 240, The slot 240 acts as a guide as the clevis pin 244 is manually adjusted between a downward position as shown. in FIG. 13, and an upward position (not shown) where the handle 250 is rotated outward to the side surface 242. In the downward position, the clevis pin 244 locks the upper pivot pin 233 within the upper clevis 230, and in the upward position, the clevis pin 244 allows the upper pivot pin 233 to be removed or disengaged from the upper clevis 230.

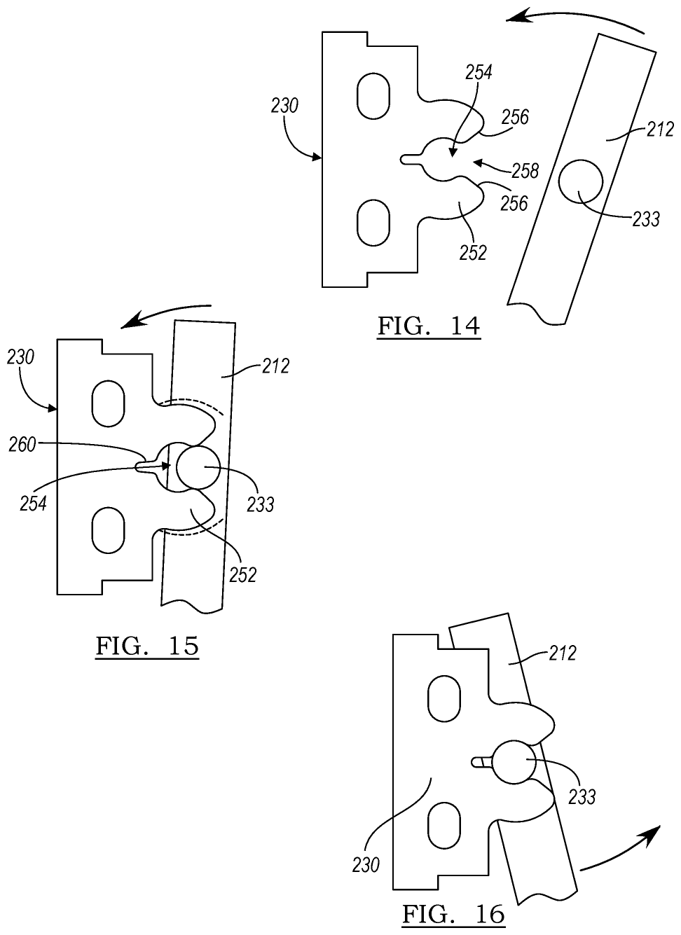

With reference to FIG. 14, the upper clevis 230 provides a self-alignment feature for receiving the upper pivot pin 233, The upper clevis 230 includes a body 252 that defines a cavity 254. The cavity 254 is formed in a semi-cylindrical shape according to one or more embodiments. The body 252 is formed with two opposing segments with lead-in surfaces 256 formed at their distal ends. The lead-in surfaces 256 are angularly spaced apart from each other and extend radially outward from the cavity 254 to define an opening 258 for receiving the upper pivot pin 233. The lead-in surfaces 256 provide an alignment feature to account for tolerance variation in the tailgate 212.

Referring to FIGS. 15 and 16, the upper clevis 230 retains the upper pivot pin 233 after it is received within the cavity 254. The upper clevis 230 is formed from a polymeric material such as an acetal, which allows it to elastically deform. The spacing between an innermost point of the inclined surfaces 256 at the opening 258 is less than the outer diameter of the upper pivot pin 233, which causes the upper and lower half of the body 252 to expand outward, as illustrated by dashed lines in FIG. 15, to receive the upper pivot pin 233. Once the upper pivot pin 233 is received within the cavity 254 the internal stress of the upper clevis 230 returns the body 252 to its normal shape to retain the upper pivot pin 233. In one or more embodiments the upper clevis 230 includes a slot 260 that extends radially outward from the cavity 254 to provide a hinge for facilitating elastic deformation of the body 252.

The upper clevis 230 is formed of a low friction and wear resistant material to provide a bearing surface for the upper pivot pin 233 as the tailgate 212 is pivoted. one embodiment, the upper clevis 230 is formed of acetal, such as Daring acetal homopolymer by DuPont, Each upper clevis 230 and lower clevis 228 is formed in generally the same shape and materials, therefore the features described with reference to each upper clevis 230 are applicable to each lower clevis 228.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A trailer comprising:
a frame to connect to an off-road vehicle;
a body, pivotally connected relative to the frame, with a bed and a side panel extending transversely from the bed to define a cargo area;
a pitch actuator assembly coupled between the frame and the body to pivot the body between a storage position and an elevated position;
a bracket connected to a rearward end of the side panel; and
a tailgate pivotally connected to a lower portion of the bracket about a first horizontal axis to adjust between a closed position and an open-downward position, and pivotally connected to an upper portion of the bracket about a second horizontal axis to adjust between the closed position and an open-upward position.

2. The trailer of claim 1, further comprising:
a first pin, supported by at least one of the bracket and the tailgate to engage the other of the bracket and the tailgate along, the first horizontal axis, to provide a first pivotal connection; and
a second pin, supported by at least one of the bracket and the tailgate to engage the other of the bracket and the tailgate along the second horizontal axis, to provide a second pivotal connection.

3. The trailer of claim 1 further comprising:
a first pin mounted for translation relative to the lower portion of the bracket along the first horizontal axis and spring-biased to extend into a first aperture formed in the tailgate to provide a first pivotal connection; and
a second pin mounted for translation relative to the upper portion of the bracket along the second horizontal axis and spring biased to extend into a second aperture formed in the tailgate to provide a second pivotal. connection.,

4. The trailer of claim 1 further comprising:
a pivot pin extending outward from the tailgate; and
a clevis mounted to the bracket and defining a cavity to receive the pivot pin along one of the first horizontal axis and the second horizontal axis to provide a pivotal connection. 5, The trailer of claim 4 further comprising a clods pin mourned for translation relative to the clevis between a downward position in which the clevis pin is disposed rearward of the pivot pin, and an upward position in which the clevis pin is disposed vertically adjacent to the clevis to facilitate removal of the pivot pin from the clevis.

6. The trailer of claim 4, Wherein the clevis comprises:
a body;
an upper segment extending from the body with an upper lead-in surface formed at an upper distal end; and
a lower segment, extending from the body and spaced apart from the upper segment to collectively form the cavity, with a lower lead-in surface formed at a lower distal end and angularly spaced apart from the upper lead-in surface to define an expanding opening to the cavity to align the pivot pin during reception.

7. The trailer of claim 6, wherein a distance between the upper lead-in surface and the lower lead-in surface at the opening is less than an outer diameter of the pivot pin such that the clevis elastically deforms to receive the pivot pin and returns to its original shape after reception to retain the pivot pin within the cavity.

8. The trailer of claim 1 further comprising:
an upper pivot pin extending outward from an upper portion of the tailgate;
an upper clevis mounted to an upper portion of the bracket to receive the upper pivot pin along the second horizontal axis;
a lower pivot pin extending outward from a lower portion of the tailgate; and
a lower clevis mounted to a lower portion of the bracket to receive the lower pivot pin along the first horizontal axis.

9. The trailer of claim 8 wherein the bed comprises a wheel well with an upper surface aligned with the upper clevis such that the upper pivot pin engages the upper surface to limit upward adjustment of the tailgate to a generally horizontal position to provide a raised platform.

10. The trailer of claim 1 wherein the pitch actuator assembly further comprises:
a linkage assembly pivotally connected between the frame and body; and
a linear actuator, supported by the linkage assembly and pivotally connected relative to the frame, to adjust the body between the storage position and the elevated position.

11. The trailer of claim 10, wherein the linkage assembly further comprises:
a first link with a forward end and a rearward end, the rearward end pivotally connected to the frame about a first joint;
a second link with. a front end and a rear end, the front end pivotally connected to the forward end of the first link; and
an upper link mounted to the body with a forward end and a rearward end, the forward end pivotally connected to the rear end of the second link; and
wherein the linear actuator comprises a proximal end pivotally connected to a central portion of the first link, and a distal end pivotally connected to the rearward. end of the upper link.

12 A trailer comprising:
a frame to connect to an off-road vehicle;
a body, supported by the frame, with a bed and a side panel extending transversely from the bed to define a cargo area, wherein the body is pivotally connected relative to the frame to adjust between a storage position and an elevated position;
a bracket connected to a rearward end of the side panel; and
a tailgate pivotally connectable to a lower portion of the bracket about a first axis to adjust between a closed position and a first open position, and pivotally connectable to an upper portion of the bracket about a second axis to adjust between the closed position and a second open position.

13. The trailer of claim 12 further comprising:
a first link with. a forward end and a rearward end, the rearward end pivotally connected to the frame about a first joint;
a second link: with. a front end and a rear end, the front end pivotally connected to the forward end of the first link;
an upper link mounted to the body with a forward end and a rearward end, the forward end pivotally connected to the rear end of the second link; and
a linear actuator with a proximal end pivotally connected to a central portion of the first link to travel along an arcuate path in response to pivotal motion of the first link, and a distal end pivotally connected to the rearward end of the upper link to extend to adjust the body between the storage position and the elevated position.

14. The trailer of claim 12, further comprising:
a first pin supported by at least one of the bracket and the tailgate to engage the other of the bracket and the tailgate along the first axis to provide a first pivotal connection; and
a second pin supported by at least one of the bracket and the tailgate to engage the other of the bracket and the tailgate along the second axis to provide a second pivotal connection.

15. The trailer of claim 12 further comprising:
a first pin mounted for translation relative to the lower portion of the bracket along the first axis and spring-biased to extend into a first aperture formed in the tailgate to provide a first pivotal connection; and
a second pin mounted for translation relative to the upper portion of the bracket along the second axis and spring-biased to extend into a second aperture formed in the tailgate to provide a second pivotal connection.

16. The trailer of claim 12 further comprising:
a pivot pin extending outward from the tailgate; and
a clevis mounted to the bracket and defining a cavity to receive the pivot pin along one of the first axis and the second axis to provide a pivotal connection.

17. A trailer comprising:
a frame to connect to an off-road vehicle;
a body, supported by the frame, with abed and a side panel extending transversely from the bed to define a cargo area, wherein the body is pivotally connected relative to the frame and adjustable between a storage position and an elevated position;
a linkage assembly coupled between the frame and the body with a first link pivotally connected to the frame about a first joint; and
a linear actuator supported by the linkage assembly to travel along an arcuate path in response to pivotal motion of the first link, and to extend to adjust the body between the storage position and the elevated position.

18. The trailer of claim 17 further comprising:
a bracket connected to a rearward end of the side panel; and
a tailgate pivotally connectable to a lower portion of the bracket about a first horizontal axis to adjust between a closed position and an open-downward position, and pivotally connectable to an upper portion of the bracket about a second horizontal axis to adjust between the closed position and an open-upward position.

19. The trailer of claim 18 further comprising:
a first pin mounted for translation relative to the lower portion of the bracket along the first horizontal axis and spring-biased to extend into a first aperture formed in the tailgate to provide a first pivotal connection; and
a second pin mounted for translation relative to the upper portion of the bracket along the second horizontal axis and spring-biased to extend into a second aperture formed in the tailgate to provide a second pivotal connection.

20. The trailer of claim 18 further comprising:
a pivot pin extending outward from the tailgate; and
a clevis mounted to the bracket and defining a cavity to receive the pivot pin along one of the first horizontal. axis and the second horizontal axis to provide a pivotal connection.
